(19) United States
(12) Patent Application Publication
(10) Pub. No.: US 2008/0199827 A1
(43) Pub. Date: Aug. 21, 2008

(54) Method for Producing a Guiding Member for Guiding a Surgical Tool, and Guiding Member Produced According to This Method

(76) Inventor: Lukas Kamer, Arth (CH)

Correspondence Address: THE WEBB LAW FIRM, P.C., 700 KOPPERS BUILDING, 436 SEVENTH AVENUE, PITTSBURGH, PA, 15219, US

(21) Appl. No.: 12/065,369

(22) PCT Filed: Aug. 9, 2006
(86) PCT No.: PCT/CH2006/000418

§ 371 Date: Feb. 29, 2008

(30) Foreign Application Priority Data
Sep. 7, 2005 (CH) 01463/05

(51) Int. Cl. A61C 1/08; G06K 9/00

(52) U.S. Cl. 433/75; 378/21; 378/38; 433/50; 382/131

(57) ABSTRACT

In order to produce a device for guiding a surgical tool, a support repositionable on a human body is produced. Three-dimensional radiological information delivered by said support and the treatable area of the human body are used for developing a virtual model of the support and the human body treatable area by means of computer assistance. Said virtual model makes it possible to determine at least one axis and to transfer said axis onto the repositionable support, thereby enabling it to be produced directly on a patient's jaw or the model thereof.

The invention relates to a method for producing a guiding member for guiding a surgical tool, in which method a support that can be repositioned on the human body is produced, three-dimensional radiological information is obtained from this support and from the treatable area of the human body, said information is used to create a virtual model of the support and of the treatable area of the human body with computer assistance, at least one axis is determined on the basis of this virtual model, and this axis is transferred to the repositionable support. The invention also relates to a guiding member that is produced according to said method.

A method of said type has been disclosed, for example, in WO 2005/023138 A. This method is used for inserting dental implants in the jaw area in an intervention in which a missing tooth is replaced. The implant is anchored in the bone and is made, for example, of titanium or a titanium alloy. An artificial tooth crown is secured on the anchored implant.

During diagnosis and planning, and during the surgical intervention, the individual relationships have to be studied with care, so as to be able to drill the bone at a suitable location and form a bore for receiving said implant. Account must be taken of the anatomical relationships, for example the position of the roots of adjacent teeth, the position of the maxillary sinus and of the endosseous blood vessels and nerves, the quality and the quantity of the bone, and also esthetic and functional aspects. During the operation, the bone is often locally exposed by cutting a flap of soft tissue in order to provide a better view. The location and the direction of the hole drilled in the bone are usually determined manually and by sight. Various technical aids for positioning of dental implants are now known. In the method according to the said WO 2005/023138 A, a plastic splint equipped with metal balls is used that is secured to the patient's teeth and alveolar ridge prior to X-ray diagnosis. The position of the metal balls is correlated with the clinical situation by means of computed tomography (CT) or other sectional imaging techniques. This is intended to provide a drilling aid.

The advantage of a suitable drilling aid is seen in the fact that, on the one hand, it can greatly simplify the surgical intervention from the technical point of view and, on the other hand, it allows a bore to be drilled for the implant without cutting a flap of soft tissue. In addition, the operating time, the surgical trauma and subsequent postoperative complications, for example swelling, pain, bleeding and infection, could be reduced and, finally, patient safety and patient comfort could be improved.

In order to produce the drilling aid, a model of the jaw, for example a plaster model, has to be made, which is relatively complicated.

In the method according to said WO 2005/023138 A, there is the further problem that the metal balls can generate important artifacts, particularly in CT, and these make precise determination of the position of the bore difficult. The ball shape has the disadvantage that the position determination, and in particular the determination of the midpoint of the equatorial plane, can only be done on sectional image reconstructions. The absolute and the relative size of the ball (i.e. relative to the CT section thickness) additionally have a critical influence on the position determination. A small metal ball generates fewer metal artifacts and can thus be more easily discerned. However, the image quality thereof is more greatly affected by partial volume defects, image resolution and, above all, CT section thickness. To determine the implant axis, it is necessary to carry out (manual) measurements of distances and angles. These can potentiate the stated technical inaccuracies.

The object of the invention is to make available a method and a guiding member that avoid the stated difficulties. In particular, the invention is intended to permit easier and less expensive production of a guiding member.

The object of the invention is to make available a method of said type that permits less expensive production of the guiding member.

The method is achieved according to claim 1. In the method according to the invention, the support has securing means, for example a modeling compound or a screw, and is mounted with this directly on the treatable area, for example on the jaw of a patient or on another bone. The modeling compound is plastically deformed or modeled according to the shape of the area, for example the shape of the patient's teeth, and can then be repositioned very precisely on account of the impression that is taken.

According to one development of the invention, the modeling compound hardens or is hardened after an impression is taken. The compound can be made such that it hardens on the patient and, in an at least partially hardened state, is removed for example from the patient's jaw.

According to one development of the invention, the guiding member is made up of a support and of said compound, the support being made of a comparatively stable material, for example a suitable plastic. The support can be designed as a vessel or receptacle that receives the modeling compound.

According to one development of the invention, means are arranged on the guiding member and are used to generate a computer-assisted spatially defined coordinates system. These means can be formed by said support, which thus assumes a further function. Alternatively, a body suitable for generating a coordinates system can also be secured on the support of the guiding member. This body is preferably noncircular and/or is made of a material substantially free of metal. The body can be made from a radiopaque plastic, for example, and can contain barium sulfate in an amount that makes the body visible by radiology.

According to one development of the invention, a positioning means is provided which can be secured in the desired position on the guiding member and which, taking into account the opposing jaw, marks the suitable clinical position of a tooth that is to be implanted. This positioning means permits a clinical position marking that can later be verified on the computer model and, if necessary, optimized. The positioning means consists in particular of a pin and of a securing mechanism on the guiding member. The part of the positioning means that indicates the clinical position is designed to be visible by radiology.

According to one development of the invention, the positioning means is secured using a grid mounted on the guiding member, in particular a microgrid. The positioning means can then be mounted in the desired position on the support. However, other securing devices are also conceivable.

Three-dimensional radiological information can be obtained here particularly by computed tomography, which is suitable particularly for spatial presentation and evaluation of the bone tissue, i.e. the tissue supporting the implant. Alternatively, digital volume tomography (DVT) (also called cone beam computed tomography (CBCT)) is also suitable in the craniofacial area. The radiation exposure is much less than in CT. Moreover, devices with reduced scanning volume are available that record only a segment of the jaw.

In the method according to the invention, virtual three-dimensional, rotatable and displaceable models are generated by means of said imaging method and preferably with computer-assisted programs. In combination with corresponding sectional images, this type of presentation serves as a basis for computer-assisted planning of the implant position or of another position for a surgical intervention. Various possibilities are available for the virtual metric analysis and planning. For example, distance, surface, volume and angle measurements can be determined both on the sectional images and also on a three-dimensional reconstruction. Axes and geometric bodies can be constructed and positioned. Each individual radiological image element or volume element (pixel or voxel) can be spatially determined by spatial coordinates.

From said guiding member or parts of the guiding member, a coordinates system is generated in the computer, and the planned implant axis for the guiding member or parts thereof is thus fixed by coordinates.

To generate a computer-assisted coordinates system, at least three fixed points (e.g. three corners) on the guiding member have to be known. However, a coordinates system can be determined relatively easily if said means are formed by additional application of a noncircular geometric shaped body. This body is a rectangular parallelepiped or a prism and in particular a cube with edges and corners that are arranged in such a way that, for example, three edges and one corner define a coordinates system.

If there is any loss of precision, for example as a result of what is called mesh formation or a smoothing effect, an exact virtual model, contained for example in the manner of a template in the computer software, can be used to bring the geometric shape by image superpositioning, for example by surface matching, into the position of the imprecisely reconstructed geometric shape. The coordinate points of the coordinates system can then be read off more exactly on this image transfer template. Alternatively, similar effects can be achieved if three surfaces at right angles to each other are applied on the geometric figure. Sharp edges and corners improve the reading accuracy, i.e. points can be assigned more clearly to a pixel or voxel coordinate value.

After the radiological imaging has been carried out, the guiding member is removed (from the patient's mouth). The planning of the implant axis (or of another axis provided for a surgical intervention) is carried out on the computer model, said axis being exactly defined in relation to the guiding member by coordinate values. The implant axis is transferred from the computer model to the guiding member by means of a computer-assisted drilling or positioning device, and once again the position of the guiding member in relation to said device is exactly defined by means of a coordinates system and a positioning element.

After the implant position/axis has been fixed on the guiding member, the latter can then be correctly positioned again on the patient and, for example, serve as a drilling aid for tooth implantation directly on the patient.

The method according to the invention is characterized particularly in that the guiding member can be produced directly on the patient without the aid of a model, thus cutting down on costs and saving time. The aforementioned substantially metal-free guiding member can also be produced alternatively as a model (e.g. a plaster model), although this takes up more time and is more costly. To this end, it is in most cases necessary for it to be produced outside the clinic by specialized technicians.

Since said means for generating a computer-assisted spatial coordinates system are substantially free of metal, it is possible to avoid metal artifacts. These greatly reduce the quality of the radiological image.

The method makes it possible, for example, for a hole for a (tooth) implant to be drilled simply by means of a drilling operation on the patient. It is not necessary to prepare a flap of soft tissue, with the result that the aforementioned advantages, for example shorter operating time, less surgical trauma, etc., can be achieved with savings in cost and time.

The guiding member produced by this method forms for example, and preferably, a drill template for the anchoring of dental implants in the jaw. In principle, however, the guiding member can also be used for other surgical interventions. For example, the guiding member can be used to guide a probe or an instrument for insertion of an implant or of a surgical instrument.

The invention also relates to a guiding member produced according to the method of claim 1. It comprises a support than can be repositioned on the human body. This support has means with which a computer-assisted spatially defined coordinates system can be generated. According to one development of the invention, these means are noncircular and preferably have at least one corner and two preferably three corners issuing from this corner. The coordinates system can be defined particularly precisely in the virtual model on the basis of these means, which accordingly ensures an exact bore for the implant.

According to one development of the invention, a securing device for a positioning aid is arranged on the guiding member for fixing the clinical implant position on the patient, for example in relation to the position of the teeth of the opposing jaw. The position of the positioning aid is compared to the subsequent plan on the computer model and can be corrected to take account of radiological occurrences.

Illustrative embodiments of the invention are explained in more detail below with reference to the drawing, in which:

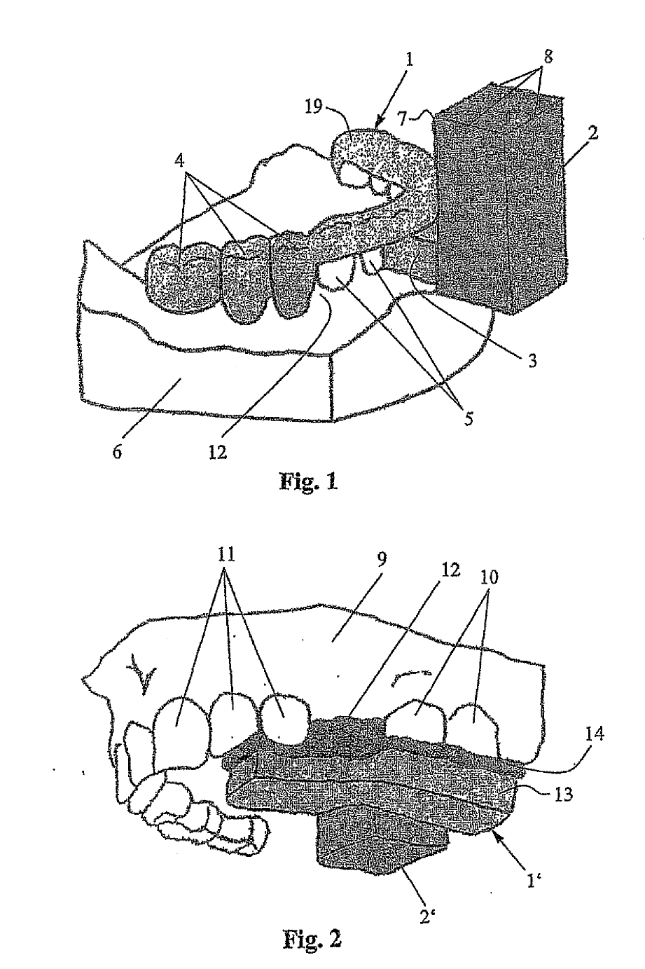

FIG. 1 is a schematic representation showing a spatial configuration of a guiding member according to the invention on a jaw model,

FIG. 2 is a schematic representation showing a spatial configuration of an alternative design of the guiding member on a jaw of a patient,

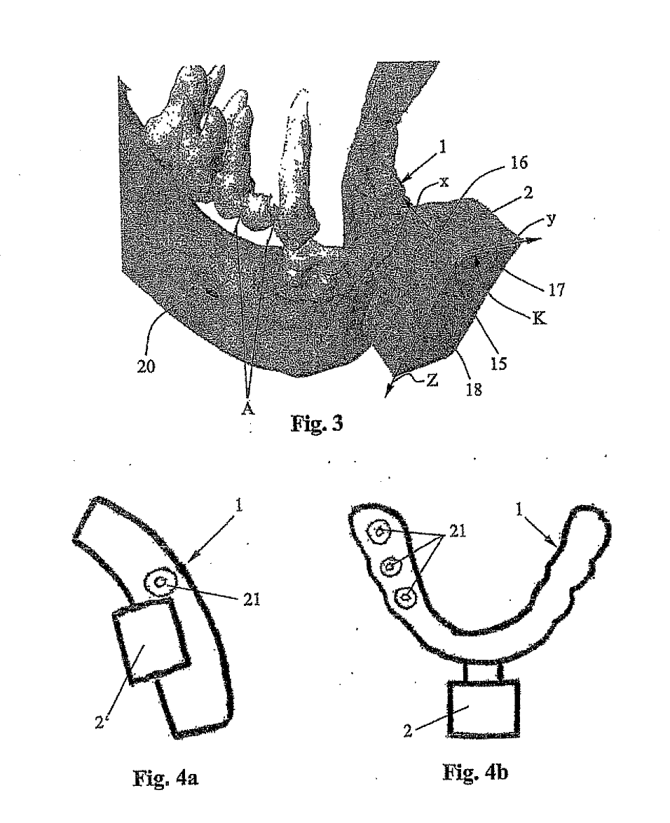

FIG. 3 shows a three-dimensional computed tomography reconstruction with some of the relevant teeth of the upper jaw and with part of the lower jaw bone, and with the guiding member according to the invention as per FIG. 1 (the upper jaw bone is not depicted),

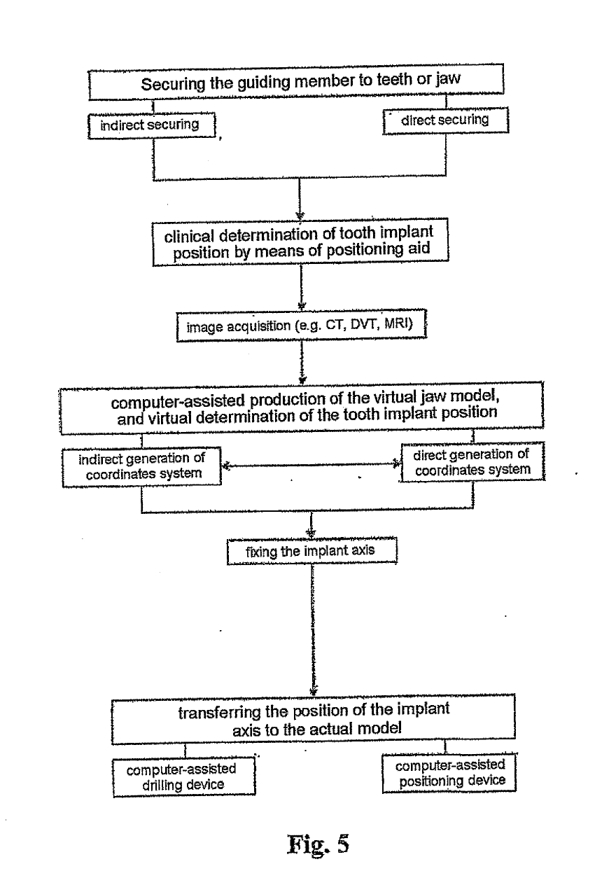

FIG. 4a shows a schematic view of the guiding member according to the invention as per FIG. 2,

FIG. 4b shows a schematic view of the guiding member according to the invention as per FIG. 1,

FIG. 5 is a schematic representation of the individual steps in the method according to the invention,

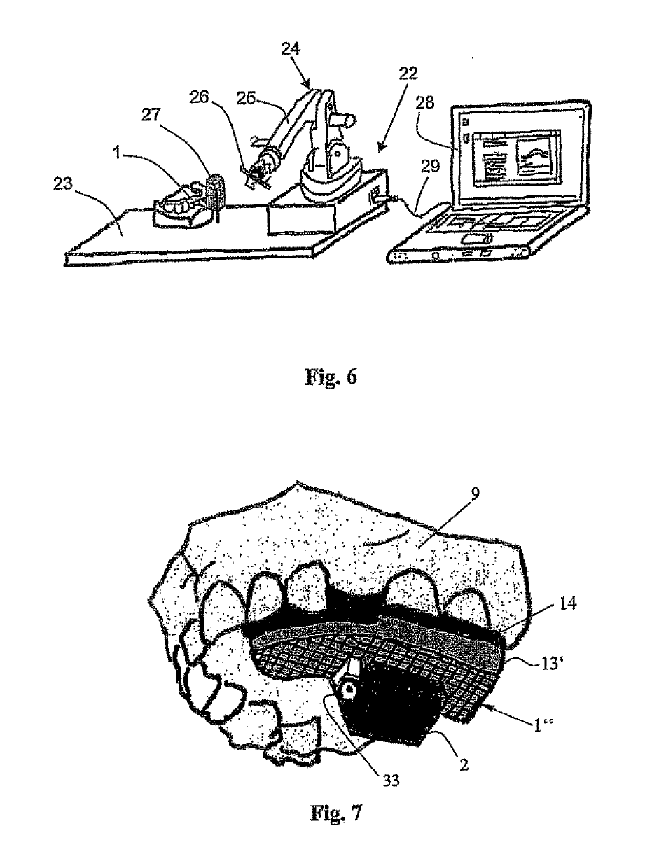

FIG. 6 is a schematic representation of an arrangement with a drilling or positioning device, a positioning means, a computer, and a guiding member that is to be positioned,

FIG. 7 is a schematic representation of a spatial configuration of a guiding member arranged on an upper jaw, according to a further variant, and a positioning means secured thereon,

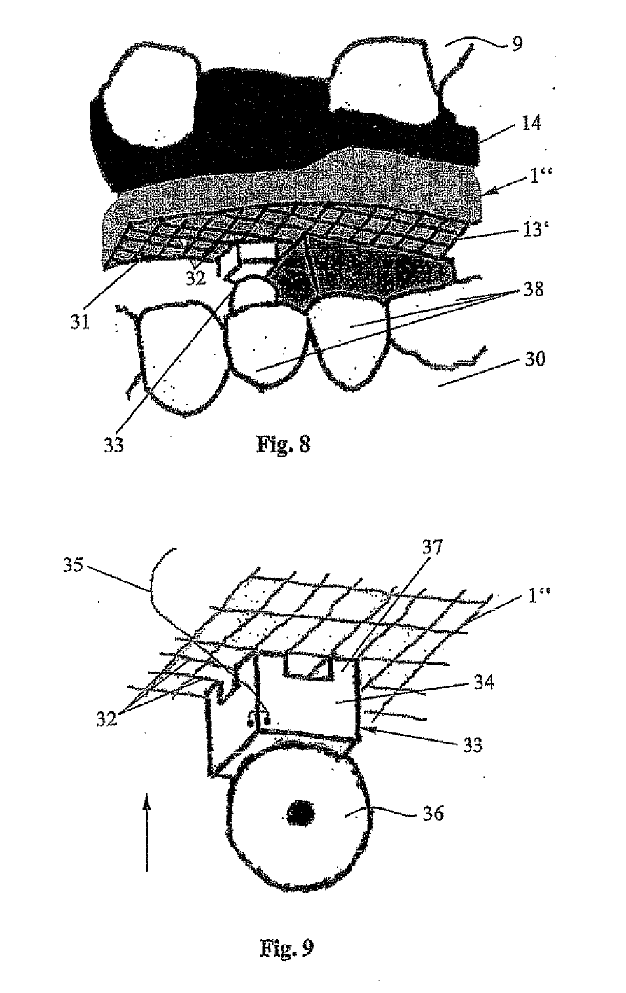

FIG. 8 is a further schematic representation of a spatial configuration of the guiding member as per FIG. 7, with part of the lower jaw being depicted,

FIG. 9 shows an enlarged schematic view of a positioning means which is mounted on the only partially depicted guiding member, and

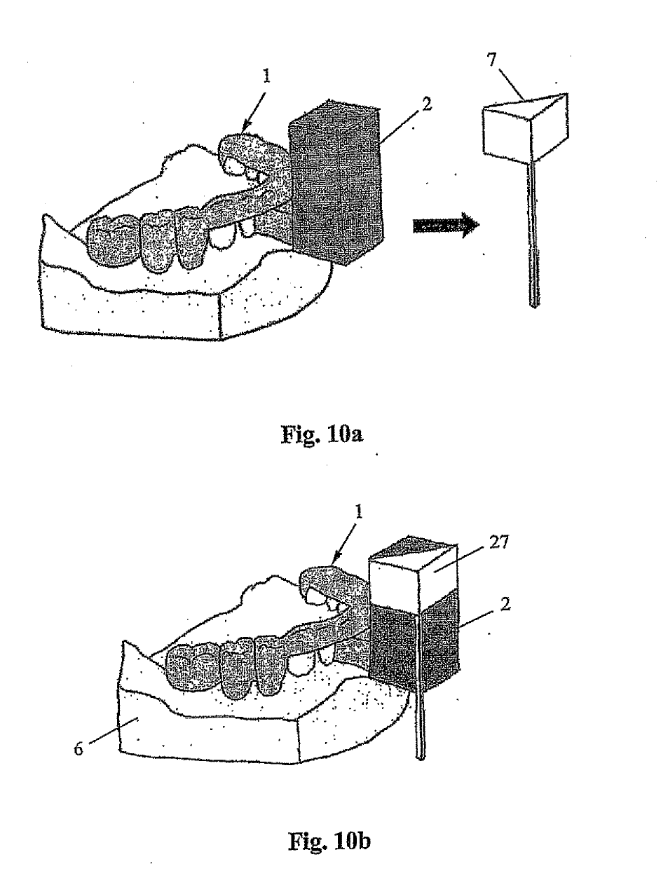

FIGS. 10a, 10b show schematic representations of the positioning of the guiding member on a positioning means.

FIG. 1 shows a guiding member 1, which is produced on a jaw model 6. It comprises a support 19, which is mounted in a repositionable manner on teeth 5 of the jaw 6. The support 19 is made of a suitable plastic, for example, and comprises modeled teeth 4 in the area of a gap 12. The support 19 is preferably firmly connected to a shaped body 2 via a bridge 3 or another suitable connecting means. In this illustrative embodiment, the shaped body 2 is a rectangular body with edges 8 and corners 7. However, the shaped body 2 can also be another noncircular geometric body, for example a prism, a rectangular parallelepiped or a cube. The shaped body 2 is thus secured in a repositionable manner on the teeth 5 and lower jaw 6 via the bridge 3 and the support 19. The support 19 can be secured with the shape body 2 very precisely in the same position again on the jaw 6. The position and orientation of the shaped body 2 with respect to the teeth 5 and to the jaw 6 is therefore always identical. A design is also conceivable in which the support 19 itself is designed such that it can assume the function of the shaped body 2.

The guiding member 1′ shown in FIG. 2 is secured directly on the jaw 9 of the patient. For this purpose, a receptacle 13 is provided which holds a modeling compound 14 that hardens or can be hardened. A shaped body 2′ corresponding to the shaped body 2 shown in FIG. 1 is secured on the receptacle 13. The guiding member 1′ is placed on the jaw 9 in such a way that teeth 10 and 11, between which a gap 12 is arranged, engage in the soft and unhardened modeling compound 14. The modeling compound 14 hardens or is hardened, and the guiding member 1′ is then removed from the jaw 9. Examples of suitable modeling compound 14 are polyether rubber, siloxanes or alginates. By means of the depressions remaining in the hardened modeling compound 14, the guiding member 1′ can be repositioned exactly on the jaw 9. In this case too, the receptacle 13 can be designed such that it can assume the shape and function of the shaped body 2′. The guiding member 1′ can extend over a part or all of the jaw 9.

In the guiding member 1 according to FIG. 1, the shaped body 2 is arranged such that, as can be seen, it is situated outside of the teeth 5 and therefore slightly below the nose. By contrast, the shaped body 2′ is situated within the jaw 9. The shaped body 2 can thus be positioned variably on the guiding member 1 or 1′.

The direct production of the guiding member 1′ has the important advantage that the corresponding preparation and adaptation on a jaw model is not necessary, and production is therefore not only quicker but also less expensive.

After the guiding member 1 or 1′ has been secured on the corresponding jaw, a sectional image is taken in a first step, and, in a second step, a computer-assisted three-dimensional model is produced which includes the guiding member 1 or 1′ and the corresponding part of the jaw. The corresponding image data can be generated using computed tomography or DVT or MRI in particular. These methods are known per se to persons skilled in the art. Based on such data, three-dimensional models can be generated with known computer programs in combination with sectional image displays. A coordinates system is generated preferably directly on the basis of the shape body 2 or 2′.

The coordinates system is determined using the geometric shape of the shaped body 2 or 2′, which in particular are rectangular shapes, for example cube or pyramid shapes, that have three adjacent edges which intersect at a corner 7 or at another suitable point. The corner 7 then forms the origin of the coordinates. The coordinates system K is digitally defined by reading off the coordinates data of the origin of the coordinates and a respective point on the x-axis, y-axis and z-axis using a suitable computer program. According to FIG. 3, the x-axis is defined by an edge 16, the y-axis by an edge 17, and the z-axis by an edge 18 of a rectangular parallelepiped. The corner 15 forms the origin of the coordinates system K. It is also conceivable for the coordinates system to be generated on corners and edges of the guiding member 1 or 1′ or parts thereof, for which purpose at least three corners must be defined. The application of a shaped body 2 or 2′ is then no longer necessary.

If difficulties or inaccurate readings arise in the computer-assisted construction process, for example as a result of the so-called smoothing effect at edges, the geometric shape can be adapted by superpositioning of images, for example by means of a template held in the computer pro gram. In this way it is possible to more precisely read off the coordinate points of the coordinates system K. Alternatively, a similar effect can be achieved by applying three superposed rectangular surfaces of the geometric figure. In this way, comparatively sharp edges 16-18 and at least one corner 15 can be displayed, which affords increased reading accuracy. Points can thus be clearly assigned to a pixel or voxel coordinate value. As an alternative to direct generation of a coordinates system, an indirect generation of the coordinates system is also conceivable. A geometric figure in the form of three points is used and, from the plane thereby defined, a spatially unique and reducible coordinates system is defined with suitable software.

The precision of the method for generating a coordinates system can be improved if said direct method and the indirect method of generating the coordinates system are combined. If a determined deviation between the two methods is small, an arithmetic mean can be formed, for example. If the deviation is greater than a predetermined value, then the two methods are checked. Greater precision and greater reliability can thus be achieved.

A further step involves fixing the implant axis or implant axes. Using a suitable computer program, the implant axis is spatially defined on the sectional image or the virtual three-dimensional reconstruction. At least two points of this implant axis and therefore two points per implant are then fixed and are determined in the form of coordinate points in relation to the coordinates system. To be able to achieve the greatest possible precision, the points of each pair of points should be located as far as possible from each other. It is important that measurements, for example angle measurements or distance measurements, are not needed for determining the implant axis.

In a further step, the position of the implant axis or of the implant axes is transferred to the guiding member 1 or 1′ and spatially fixed. This is done, for example, with the arrangement 22 shown in FIG. 6. This arrangement 22 comprises a plate 23 on which a positioning element 27 is secured. A device 24, for example a robot known per se, is also arranged on the plate 23 and is connected via a signal line 29 to a computer 28. The device 24 comprises a movable controlled arm 25, on which a part 26 is secured, which can be a drill or a positioning pin for securing a drill sleeve (not shown here). The device 24 is in a predetermined position relative to the positioning element 27. The planning data and in particular the coordination data of the implant axis in relation to the coordinates system are transferred from the computer 28 to the device 24. This positions a drill sleeve 21 on the guiding member 1 or drills this directly.

FIGS. 7 to 9 show a guiding member 1″ according to a further variant. With this guiding member 1″, it is possible for the implant position relative to the position of teeth 38 of an opposing jaw 30 to be defined clinically on the patient. On the receptacle 13′ there is a securing device 31, which is preferably designed as a grid. A positioning means 33 can be secured on this securing device 31 at any desired position within the grid. The grid can have very small meshes, such that the positioning means 33 can be positioned exactly with respect to the teeth 38.

According to FIG. 9, the positioning means 33 has a foot part 34 with four plug-on parts 37 which engage in grooves 32 of the receptacle 13′. The securing is thus effected according to a matrix/patrix system known per se. However, other securing means are also conceivable here: for example, the positioning means 33 could also be secured on the receptacle 13′ by means of an adhesive. The positioning means 33 also has a head part 36 for fixing the implant position. This head part preferably has a spherical shape. To ensure that the positioning means 33 cannot inadvertently come loose and be aspirated or swallowed by the patient, it is secured to the receptacle 13′ by a retaining part 35, for example a thread. The shaped body 2 corresponds in terms of its structure and function to the shaped part discussed above. With the positioning means 33, it is possible for the missing implantation tooth or implantation teeth to be defined also without a plaster model and to be integrated into the planning of the implantation position and into the drill template. A modelling process is therefore no longer necessary.

In a further step as shown in FIGS. 6, 10a and 10b, the position of the implant axis or implant axes is transferred to the guiding member 1 or 1′. FIG. 6 shows a plate 23 on which a positioning element 27 is secured. A device 24, for example a robot known per se, is also arranged on the plate 23 and is connected via a signal line 29 to a computer 28. The device 24 comprises a movable controlled arm 25, on which a part 26 is secured, which can be a drill, a positioning pin or a drill sleeve 21. The device 24 is in a predetermined position relative to the positioning element 27. The planning data and in particular the coordination data of the implant axis in relation to the coordinates system are transferred from the computer 28 to the device 24. This positions a drill sleeve 21 on the guiding member 1 or drills this directly.

FIGS. 10a and 10b show part of the arrangement according to FIG. 6. To ensure that a referencing of the guiding member 1 or 1′ can take place on the device 24, a fixed positioning element 27 on the plate 23 positions the shaped body 2 in a clearly reproducible manner with respect to the positioning element 27. The shaped body 2 and positioning element 27 here have a cube shape and fit according to the matrix/patrix principle. However, another form of referencing is also possible in which, for example, the guiding member 1 or 1′ fits into a groove-shaped positioning element.

### LIST OF REFERENCE SIGNS

1 guiding member
2 shaped body
3 bridge
4 modeled teeth
5 teeth
6 jaw model
7 corner
8 edges
9 jaw
10 teeth
11 teeth
12 gap
13 receptacle
14 modeling compound
15 corner (zero point)
16 edge
17 edge
18 edge
19 support
20 lower jaw
21 drill sleeve
22 arrangement
23 plate
24 device
25 arm
26 part
27 positioning element
28 computer
29 signal line
30 opposing jaw
31 securing device
32 grooves
33 positioning means
34 foot part
35 retainer part
36 head part
37 plug-on part
38 teeth
A implant axes
K coordinates system

1-26. (canceled)

27. A method for producing a guiding member for guiding a surgical tool, comprising the steps of:
a) producing a repositionable support adapted to be repositioned on a human body;
b) obtaining three-dimensional radiological information from the repositionable support and from a treatable area of the human body;
c) using the three-dimensional radiological information to create a virtual model of the repositionable support and of the treatable area of the human body with computer assistance;
d) determining at least one axis on the basis of the virtual model,
e) transferring the at least one axis to the repositionable support, wherein the repositionable support include securing means; and
f) mounting the repositionable support to the treatable area with the securing means.

28. The method as claimed in claim 27, wherein the securing means is a modeling compound that hardens or is hardened after an impression is taken.

29. The method as claimed in claim 27, wherein the guiding member forms a drill template.

30. The method as claimed in claim 27, further comprising the step of providing a guiding member for the positioning of dental implants.

31. The method as claimed in claim 27, wherein the position of an implant axis is fixed by an electromechanical positioning device.

32. The method as claimed in claim 27, further comprising the step of providing a guiding member for guiding a drilling tool.

33. The method as claimed in claim 27, wherein a coordinate system is specified or defined by superpositioning of images (surface matching).

34. A guiding member for guiding a surgical tool, wherein the guiding member is comprised of a repositionable support adapted to be repositioned on a human body, wherein the repositionable support includes at least one axis defined by a virtual model of the repositionable support and of a treatable area of the human body obtained via three-dimensional radiological information from the repositionable support and from the treatable area of the human body, wherein the repositionable support includes securing means adapted to mount the repositionable support to the treatable area, wherein the repositionable support further includes a modeling compound.

35. The guiding member as claimed in claim 34, wherein the guiding member is adapted to be secured directly on a jaw.

36. The guiding member as claimed in claim 35, wherein the guiding member comprises a receptacle for receiving said modeling compound.

37. The guiding member as claimed in claim 34, further comprising a positioning means for fixing an implant position in relation to the position of teeth of an opposing jaw.

38. The guiding member as claimed in claim 37, wherein the support comprises a grid for securing the positioning means.

39. The guiding member as claimed in claim 37, wherein the positioning means is pin-shaped.

40. The guiding member as claimed in claim 37, wherein the positioning means has securing means for securing the positioning means by frictional engagement.

41. The guiding member as claimed in claim 37, wherein the positioning means has a foot part for securing the positioning means, and a head part for fixing the implant position.

42. The guiding member as claimed in claim 36, wherein the guiding member is a drill template.

43. A system for producing a guiding member for guiding a surgical tool, the system comprising:
a) a computer-assisted device configured to:
i) use three-dimensional radiological information obtained from a repositionable support and from a treatable area of a human body to create a virtual model of the repositionable support and of the treatable area of the human body, wherein the repositionable support is adapted to be repositioned on the human body;
ii) determine at least one axis on the basis of the virtual model; and
iii) transfer the at least one axis to the repositionable support;
b) a positioning element configured to position the guiding member for machining thereof by the system; and
c) a drill for machining the guiding member.

44. The system as claimed in claim 43, further comprising a robotic movable arm for guiding a tool.

45. The system as claimed in claim 43, wherein the positioning element forms an abutment on which the guiding member to be machined is adapted to be applied in an exact position.

46. A method for producing a guiding member for guiding a surgical tool, comprising the steps of:
a) producing a repositionable support adapted to be repositioned on a human body;
b) obtaining three-dimensional radiological information from the repositionable support and from a treatable area of the human body;
c) using the three-dimensional radiological information to create a virtual model of the repositionable support and of the treatable area of the human body with computer assistance;
d) determining at least one axis on the basis of the virtual model;
e) transferring the at least one axis to the repositionable support; and
f) arranging means on the repositionable support, wherein the means are used to generate a computer-supported spatially-defined coordinate system, wherein the means are substantially free of metal.

47. The method as claimed in claim 46, wherein the means are designed such that they are displayed on a radiological sectional image both in terms of their size and also in terms of their shape.

48. The method as claimed in claim 46, wherein said means are formed by a noncircular geometrical body.

49. The method as claimed in claim 46, wherein said means for generating the coordinate system has at least one corner and three edges issuing from this corner.

50. A guiding member for guiding a surgical tool, wherein the guiding member is comprised of a repositionable support adapted to be repositioned on a human body, wherein the repositionable support includes at least one axis defined by a virtual model of the repositionable support and of a treatable area of the human body obtained via three-dimensional radiological information from the repositionable support and from the treatable area of the human body, and further obtained by generation of a computer-supported spatially-defined coordinate system using substantially metal-free arranging means situated on the repositionable support.

51. The guiding member as claimed in claim 50, wherein said means are noncircular.
